(19) United States
(12) Patent Application Publication
(10) Pub. No.: US 2008/0297612 A1
(43) Pub. Date: Dec. 4, 2008

(54) IMAGE PICKUP DEVICE

(76) Inventor: Koichi YOSHIKAWA, Kanagawa (JP)

Correspondence Address: FROMMER LAWRENCE & HAUG LLP, 745 FIFTH AVENUE, NEW YORK, NY, 10151, US

(21) Appl. No.: 12/125,198

(22) Filed: May 22, 2008

(30) Foreign Application Priority Data
May 25, 2007 (JP) P2007-139235

(51) Int. Cl. H04N 5/225

(52) U.S. Cl. 348/218.1; 348/E05.024

(57) ABSTRACT

An image pickup device includes a plurality of image pickup unit configured to pick up images of a plurality of respective subject segments divided from a subject in a wide range; and a processing unit configured to combine the images picked up by the image pickup unit into a single image.

### CROSS REFERENCES TO RELATED APPLICATIONS

The present invention contains subject matter related to Japanese Patent Application JP 2007-139235 filed with the Japan Patent Office on May 25, 2007, the entire contents of which being incorporated herein by reference.

### BACKGROUND OF THE INVENTION

1. Field of the Invention

The present invention relates to an image pickup device for picking up images in a wide range such as a whole-sky (omnidirectional) range.

2. Description of the Related Art

As well known in the art, there have been developed various camera systems having a number of video cameras placed in a single housing for simultaneously picking up images in an omnidirectional or fully circumferential range or a wide-angle or broad range.

In order to solve the problem of a parallax with such camera systems, an optical system for eliminating a parallax without the need for mirrors has been proposed (see, for example, Japanese Patent Laid-open No. 2003-162018).

An optical system that is free of mirrors is advantageous in that the entire camera system is small in size because it does not need to have a volume which would otherwise be required for the installation of the mirrors, and the optical system is small in size and can be handled with ease in the same way as optical systems having ordinary lenses only because of the lack of the mirrors.

According to the above optical system, the video cameras are positioned such that their NP (non-parallax) points are substantially aligned with each other. The NP point is defined as a point where the extensions of straight components, in an object space, of principal rays positioned in a Gaussian region which are selected from a number of principal rays passing through the center of the aperture stop of the optical system of the camera, intersects the optical axis of the optical system.

### SUMMARY OF THE INVENTION

Heretofore, single-CCD cameras have been used in camera systems regardless whether they are monochromatic or color systems, for the reason that the volumes around the image pickup elements are limited in order to keep the NP points of the cameras substantially aligned with each other. As a result, images picked up by the camera systems are relatively poor in color reproducibility and resolution.

The limited volumes around the image pickup elements will be described below with reference to FIG. 8 of the accompanying drawings. FIG. 8 shows in schematic cross section a camera 100 among many cameras that are combined together for simultaneously picking up images in a wide range, e.g., in an omnidirectional or fully circumferential range or a wide-angle or broad range.

In the camera 100 shown in FIG. 8, principal rays 105, 106 that have passed through respective points 111, 112 at the edge of a lens (front lens) 101 which is closest to the subject pass through a lens group 102 (with intermediate components between the lens 101 and the lens group 102 being omitted from illustration), and reach end points on the light-detecting surface of an image pickup element 103.

For picking up images in a wide range, the NP point 104 of the camera 100 is aligned with the NP points of the other cameras, and the camera 100 has an outer circumferential surface 100A held in contact with the outer circumferential surfaces 100B of adjacent ones of the other cameras.

Since the outer circumferential surfaces 100A, 100B of the adjacent cameras 100 are held in contact with each other, an electric circuit board, cables, etc. that need to be positioned near the image pickup element 103 have to be placed in a space S which is shown hatched in FIG. 8.

The space S is surrounded by the outer circumferential surfaces 100A, 100B and a plane that is perpendicular to an optical axis 107 near the image pickup element 103.

In view of the fact that the image pickup element 103, the electric circuit board, the cables, etc. are placed in the space S, the camera 100 should desirably be, and hence has heretofore been, a single-CCD camera.

Surveillance cameras or the like are highly required to pickup images of subjects in low-luminance environments. In single-CCD color cameras, the lights of colors that do not pass through the color filters are not detected by the image pickup element. For this reason, the single-CCD color cameras for picking up images in an omnidirectional or fully circumferential range or a wide-angle or broad range do not have a sufficient sensitivity level required in the application of surveillance cameras for picking up images of subjects in low-luminance environments.

It is desirable to provide an image pickup device which is excellent in color reproducibility and resolution, is capable of reducing a parallax, and is able to acquire images in a wide range.

An image pickup device according to the present invention includes a plurality of image pickup units for picking up images of a plurality of respective subject segments divided from a subject in a wide range, and processing unit for combining the images picked up by the image pickup units into a single image, each of the image pickup units including lenses and image pickup elements for detecting rays having passed through the lenses, wherein in each of the image pickup units, an NP point is defined as a point where the extensions of straight components, in an object space, of principal rays positioned in a Gaussian region which are selected from a number of principal rays passing through the center of an aperture stop associated with the lenses, intersect an optical axis of the image pickup units, the NP point is set behind the image pickup elements, and the NP points of the image pickup units are placed in a region having a radius of about 20 mm around one of the NP points, and each of the image pickup units includes separating unit for separating the rays having passed through the lenses into a plurality of groups of rays having different wavelengths which are to be detected by the image pickup elements, respectively.

With the above arrangement, the NP points of the image pickup units are disposed behind the image pickup elements, so that the optical system, including the lenses, of each of the image pickup units does not block the optical paths of the other image pickup unit. The NP points of the image pickup units are placed in a region having a radius of about 20 mm around one of the NP points, so that any parallaxes between the image pickup units are almost reduced to nil.

Since the image pickup units pickup the images of the respective subject segments divided from the subject in the wide range, the image pickup device can pickup the image of the subject in the wide range in a parallax-free manner.

The image pickup device has the separating unit for separating the rays having passed through the lenses into a plurality of groups of rays having different wavelengths which are to be detected by the image pickup elements, respectively. Therefore, the number of pixels for detecting the light in each color is greater than the number of pixels on a single-CCD image pickup device, so that the image pickup device is better in color reproducibility and resolution. The image pickup device is also capable of more efficiently detecting the incident rays for better sensitivity than the single-CCD image pickup device which is unable to detect rays that do not pass through color filters.

The image pickup device that is better in color reproducibility and resolution is thus capable of picking up high-definition images.

The image pickup device can pickup high-quality images in a wide range in a parallax-free manner.

The image pickup device is thus capable of picking up high-definition, high-quality images in a wide range such as an omnidirectional range.

Moreover, since the image pickup device can detect incident rays more efficiently for better sensitivity than the single-CCD image pickup device, the image pickup device provides excellent visibility in a low-luminance environment for picking up high-definition, high-quality images in a wide range.

The above and other objects, features, and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a schematic vertical cross-sectional view of an image pickup device according to an embodiment of the present invention;

FIG. 2 is an enlarged vertical cross-sectional view of a central portion of the image pickup device shown in FIG. 1;

FIG. 3 is a schematic horizontal cross-sectional view of the image pickup device according to the embodiment of the present invention;

FIG. 4 is an enlarged horizontal cross-sectional view of a central portion of the image pickup device shown in FIG. 3;

FIG. 5 is a plan view, as seen from the subject side of the image pickup device according to the embodiment of the present invention;

FIG. 6 is a schematic vertical cross-sectional view of an image pickup device according to another embodiment of the present invention;

FIG. 7 is an enlarged vertical cross-sectional view of a central portion of the image pickup device shown in FIG. 6; and

FIG. 8 is a schematic cross-sectional view of a camera among many cameras that are combined together for simultaneously picking up images in a wide range.

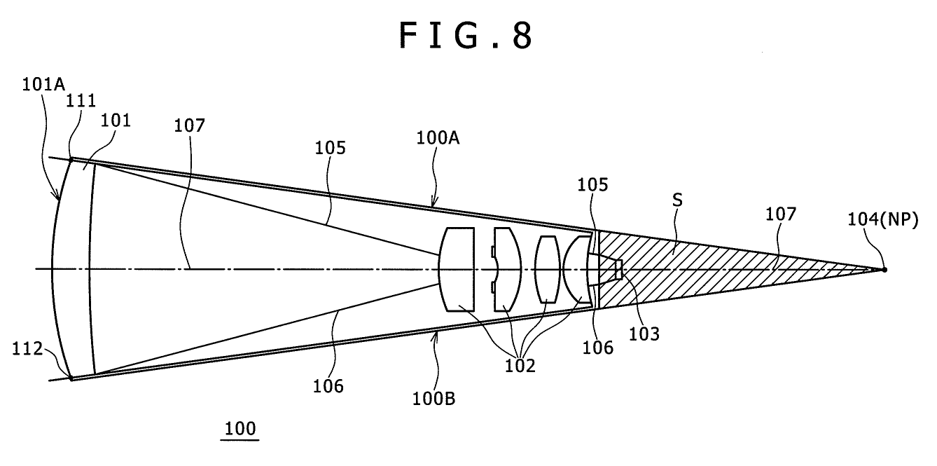

### DETAILED DESCRIPTION OF THE PREFERRED EMBODIMENT

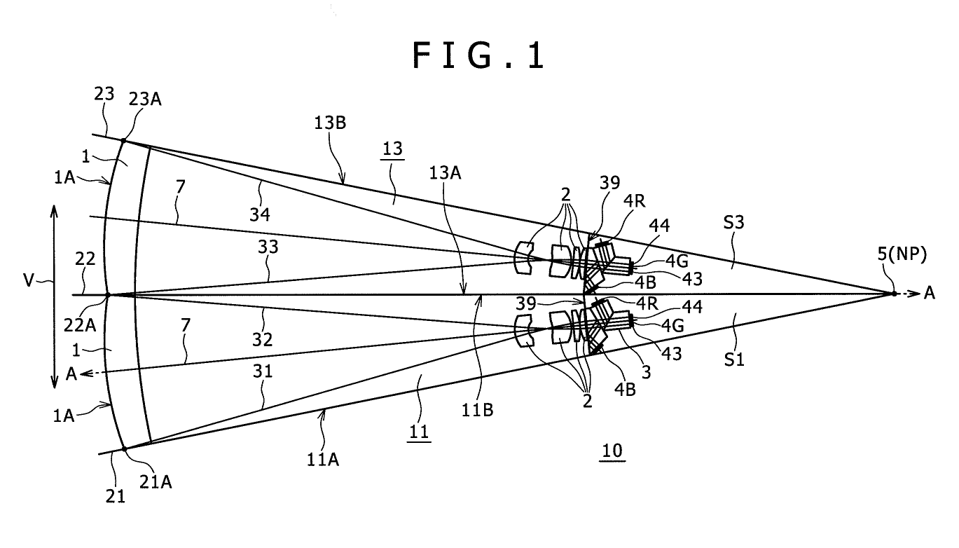

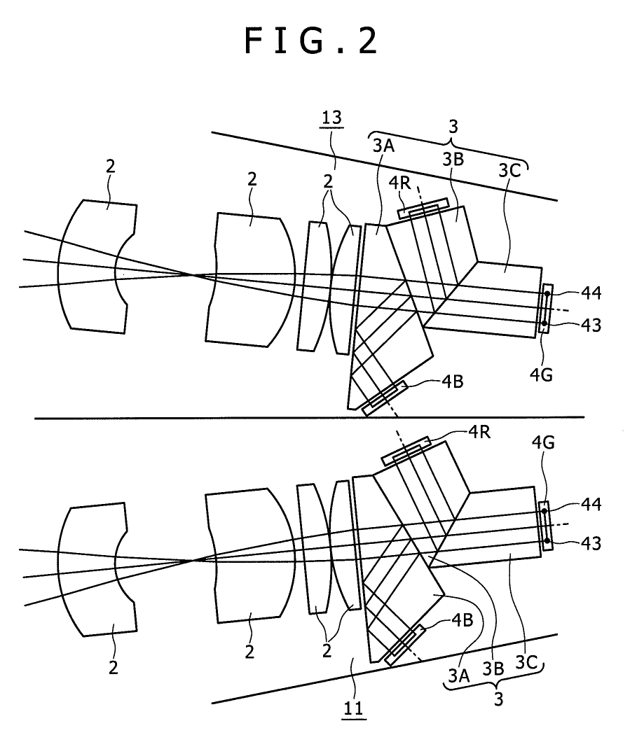

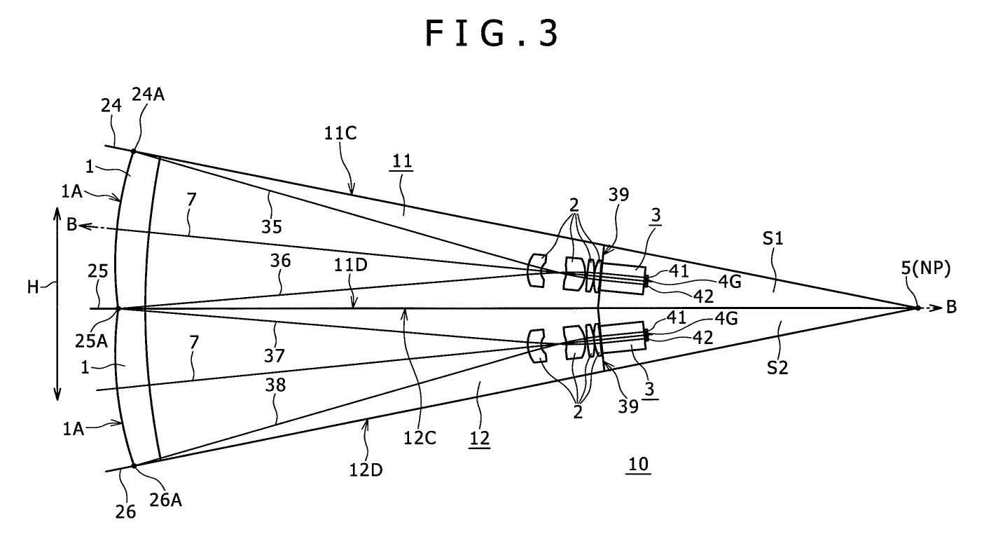

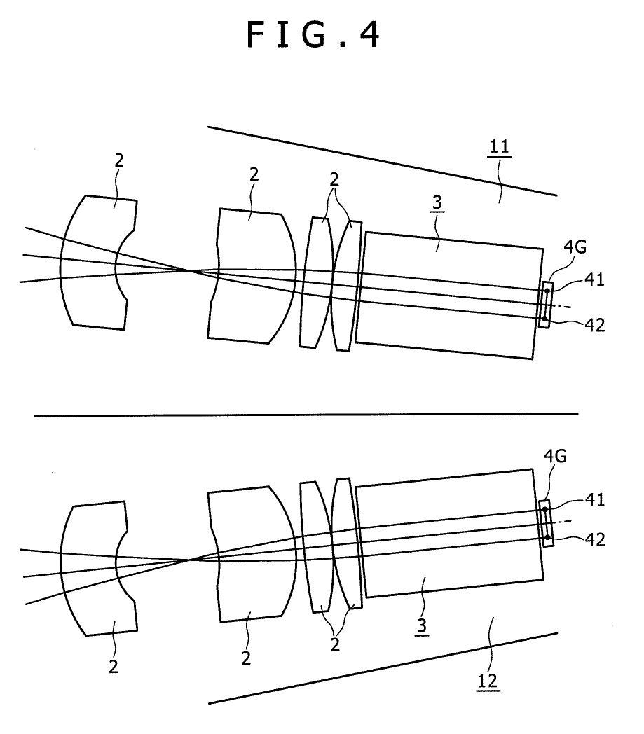

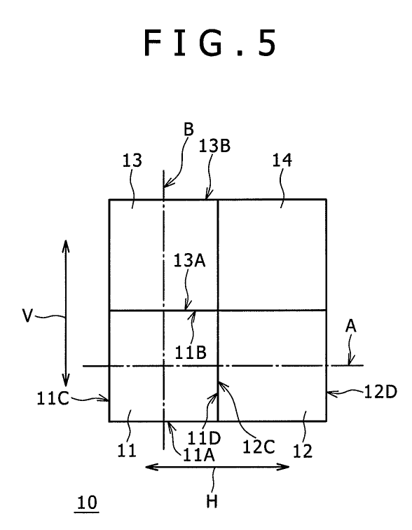

An image pickup device according to an embodiment of the present invention will be described below with reference to FIGS. 1 through 5. FIG. 1 is a schematic vertical cross-sectional view of the image pickup device, FIG. 2 is an enlarged vertical cross-sectional view of a central portion of the image pickup device, FIG. 3 is a schematic horizontal cross-sectional view of the image pickup device, FIG. 4 is an enlarged horizontal cross-sectional view of a central portion of the image pickup device shown in FIG. 3, and FIG. 5 is a plan view, as seen from the subject side of the image pickup device.

The image pickup device, generally designated by 10, includes four cameras 11, 12, 13, 14 each including a lens (front lens) 1 on its end close to the subject. The image pickup device 10 produces a single combined image from images that are picked up respectively by the cameras 11, 12, 13, 14.

Each of the cameras 11, 12, 13, 14 includes a hollow housing in the form of a quadrangular pyramid having a substantially square cross section and accommodating therein the front lens 1, a lens group 2 including four lenses, an aperture stop (not shown), and an image pickup element. The aperture stop is disposed forwardly of, within, or rearwardly of the lens group 2. For details, reference should be made to Japanese patent Laid-open No. 2004-80088 and Japanese patent Laid-open No. 2004-191593.

A space in front of (leftward in FIG. 1) the front lens 1 which is closest to the subject will be referred to as an object space.

A point where the extension of a principal ray, in the object space, that is positioned closely to an optical axis 7 of the optical system (in a Gaussian region), among rays (principal rays) passing through the center of the aperture stop, intersects the optical axis 7 is defined as an NP point 5.

The lens 1, the lens group 2, the aperture stop, etc. make up the optical system such that the NP points 5 of the cameras 11, 12, 13, 14 are present on the crests of the housings each in the form of a quadrangular pyramid. The housings each in the form of a quadrangular pyramid have side surfaces extending as a plane made up of a set of line segments interconnecting the edges of the front lenses 1 and the NP points 5.

The NP points 5 of the cameras 11, 12, 13, 14 are disposed behind the lens groups 2 and image pickup elements. To position the NP points behind the lens groups 2 and the image pickup elements, the optical systems made up of the lens 1, the lens group 2, the aperture stop, etc. may be of the telephoto type, for example.

The NP points 5 of the cameras 11, 12, 13, 14 are disposed behind the lens groups 2 and the image pickup elements, so that the optical system of each of the cameras 11, 12, 13, 14 does not block the optical paths of the other cameras.

Since the front lens 1 of each of the cameras 11, 12, 13, 14 is placed in the housing which has a substantially square cross section, the front lens 1 also has a substantially square cross section that is complementary to the cross-sectional shape of the housing. The front lens 1 thus shaped can be fabricated by cutting a spherical lens having a circular cross section along planes which do not pass through the central line thereof such that the cut lens will be of a substantially square cross-sectional shape.

FIGS. 1 through 4 illustrate cross sections in planes along the optical axes of the two vertically or horizontally arranged cameras. Specifically, FIG. 3 is a cross-sectional view in a plane along line A-A of FIG. 1, and FIG. 1 is a cross-sectional view in a plane along line B-B of FIG. 3. These planes are indicated by the dot-and-chain lines A, B in FIG. 5.

As shown in FIG. 1, the NP points 5 of the two cameras 11, 13 that are arranged along the vertical direction V are substantially aligned with each other.

As shown in FIG. 3, the NP points 5 of the two cameras 11, 12 that are arranged along the horizontal direction H are substantially aligned with each other.

Although not shown, the NP points 5 of the cameras 12, 14 and NP points 5 of the cameras 13, 14 are also substantially aligned with each other.

Therefore, the NP points 5 of the cameras 11, 12, 13, 14 shown in FIG. 5 are substantially aligned with each other.

Since the four cameras 11, 12, 13, 14 are combined with each other such that their NP points 5 are substantially aligned with each other, the cameras 11, 12, 13, 14 have their bottom surfaces slightly tilted beyond the sheet of FIG. 5, and they are not strictly square in shape in FIG. 5. However, as the length of the cameras 11, 12, 13, 14 is about five times the size of the front lens 1 as shown in FIGS. 1 and 3 and the bottom surfaces of the cameras 11, 12, 13, 14 are tilted through a small angle, the bottom surfaces are shown as being square in shape in FIG. 5.

The image pickup device 10 also includes a spectral prism assembly 3 disposed between the lens group 2 and the image pickup elements of each of the cameras 11, 12, 13, 14 as a separating unit for separating the incident rays into different wavelength ranges (red light, green line, and blue light). The rays separated by the spectral prism assembly 3 are detected by the respective image pickup elements 4R, 4G, 4B.

As shown in the horizontal direction H in FIG. 3, the NP points 5 of the two cameras 11, 12 are substantially aligned with each other, and the housings in the form of quadrangular pyramids of the cameras 11, 12 have respective side surfaces 11D, 12C held in contact with each other. Accordingly, images picked up by the two cameras 11, 12 of a subject which is located at an arbitrary distance can be joined to each other without leaving an unduly conspicuous boundary therebetween by a simple image processing process performed on the image data.

In FIG. 3, the side surface 11D of the housing of the camera 11 and the side surface 12C of the housing of the camera 12 are represented by a line segment interconnecting the NP point 5 and a point 25A where a principal ray 25 in the object space (the space closer to the subject) intersects a first surface (a lens surface facing the subject) 1A of the front lens 1.

The housing of the camera 11 has an opposite side surface 11C represented by a line segment interconnecting the NP point 5 and a point 24A where a principal ray 24 in the object space intersects the first surface 1A of the front lens 1.

The housing of the camera 12 has an opposite side surface 12D represented by a line segment interconnecting the NP point 5 and a point 26A where a principal ray 26 in the object space intersects the first surface 1A of the front lens 1.

The principal ray 24 which comes from the subject passes through the front lens 1 of the camera 11, which refracts the principal ray 25 into a principal ray 35. The principal ray 35 passes through the lens group 2 including four lenses and thereafter passes through the spectral prism assembly 3 to the light-detecting surface of the image pickup element 4G at an end point 42 in the horizontal direction H.

Similarly, the principal ray 25 which comes from the subject passes through the front lens 1 of the camera 11, which refracts the principal ray 25 into a principal ray 36. The principal ray 36 passes through the lens group 2 and thereafter passes through the spectral prism assembly 3 to the light-detecting surface of the image pickup element 4G at an end point 41 in the horizontal direction H.

The principal ray 25 also passes through the front lens 1 of the camera 12, which refracts the principal ray 25 into a principal ray 37. The principal ray 37 passes through the lens group 2 and thereafter passes through the spectral prism assembly 3 to the light-detecting surface of the image pickup element 4G at the end point 42 in the horizontal direction H. The end point 42 is angularly spaced 180° from the end point 41 across the optical axis 7.

The principal ray 26 which comes from the subject passes through the front lens 1 of the camera 12, which refracts the principal ray 26 into a principal ray 38. The principal ray 38 passes through the lens group 2 and thereafter passes through the spectral prism assembly 3 to the light-detecting surface of the image pickup element 4G at an end point 41 in the horizontal direction H.

Therefore, the optical systems of the cameras 11, 12 are arranged such that the principal rays 35, 36, 37, 38 which reach the end points 41, 42 of the image pickup element 4G pass through the points 24A, 25A, 26A on the edges of the front lenses 1. As the cameras 11, 12 have their respective image pickup ranges joined to each other without any losses, the images picked up by the image pickup elements 4G of the cameras 11, 12 can be combined with each other.

In the angle of view along the horizontal direction H which is defined between the two principal rays 24, 26 in the object space, therefore, images can be picked up without blind corners by the two cameras 11, 12.

In FIG. 3, the lens group 2 of each of the cameras 11, 12 has a lens surface closest to the image plane which intersects the optical axis 7 along a plane 39 that is perpendicular to the optical axis 7.

The plane 39 and the side surfaces 11C, 12C of the housing of the camera 11, and the plane 39 and the side surfaces 11D, 12D of the housing of the camera 12 jointly define respective spaces S1, S2 in which the spectral prism assemblies 3, the image pickup elements 4G, and camera circuits (not shown) of the cameras 11, 12 are accommodated. In this manner, the NP points of the cameras 11, 12 are substantially aligned with each other.

The side surfaces 11C, 11D, 12C, 12D of the housings are represented by planes that are described by moving line segments interconnecting the NP points 5 and the points 24A, 25A, 26A on the edges of the front lenses 1 to which the principal rays 24, 25, 26 are applied, in a direction perpendicular to the sheet of FIG. 3.

FIG. 1 is a schematic cross-sectional view of the image pickup device 10 as seen in the vertical direction V, i.e., as viewed when the image pickup device 10 shown in FIG. 3 is turned 90°.

As shown in FIGS. 1 and 2, the spectral prism assembly 3 includes three prisms 3A, 3B, 3C. An optical film for separating visible incident light according to wavelength is disposed between boundary surfaces of each of the prisms 3A, 3B, 3C and an adjacent one of the prisms 3A, 3B, 3C. These optical films separate visible incident light into red, green, and blue lights. The optical films are bonded to or grown on the boundary surfaces of the prisms 3A, 3B, 3C by coating or any of other film growing processes.

The image pickup element 4B for detecting the blue light is mounted on the first prism 3A which is closest to the lens group 2. The image pickup element 4R for detecting the red light is mounted on the second prism 3B which is disposed next to the first prism 3A. The image pickup element 4G for detecting the green light is mounted on the third prism 3C which is disposed farthest from the lens group 2.

As shown in the schematic vertical cross-sectional view in the vertical direction V in FIG. 1, similarly to the view in the horizontal direction H in FIG. 3, the NP points 5 of the two cameras 11, 13 are substantially aligned with each other, and the housings in the form of quadrangular pyramids of the cameras 11, 13 have respective side surfaces 11B, 13A held in contact with each other. Accordingly, images picked up by the two cameras 11, 13 of a subject which is located at an arbitrary distance can be joined to each other without leaving an unduly conspicuous boundary therebetween by a simple image processing process performed on the image data.

In FIG. 1, the side surface 11B of the housing of the camera 11 and the side surface 13A of the housing of the camera 13 are represented by a line segment interconnecting the NP point 5 and a point 22A where a principal ray 22 in the object space (the space closer to the subject) intersects the first surface (the lens surface facing the subject) 1A of the front lens 1.

The housing of the camera 11 has an opposite side surface 11A represented by a line segment interconnecting the NP point 5 and a point 21A where a principal ray 21 in the object space intersects the first surface 1A of the front lens 1.

The housing of the camera 13 has an opposite side surface 13B represented by a line segment interconnecting the NP point 5 and a point 23A where a principal ray 23 in the object space intersects the first surface 1A of the front lens 1.

The principal ray 21 which comes from the subject passes through the front lens 1 of the camera 11, which refracts the principal ray 21 into a principal ray 31. The principal ray 31 passes through the lens group 2 and thereafter passes through the spectral prism assembly 3. Of the visible light whose wavelength ranges from 400 nm to 700 nm, the red component (red light) reaches the light-detecting surface of the image pickup element 4R, the green component (green light) reaches the light-detecting surface of the image pickup element 4G at an end point 44 in the vertical direction V, and the blue component (blue light) reaches the light-detecting surface of the image pickup element 4B.

Similarly, the principal ray 22 which comes from the subject passes through the front lens 1 of the camera 11, which refracts the principal ray 22 into a principal ray 31. The principal ray 32 passes through the lens group 2 and thereafter passes through the spectral prism assembly 3. The red component reaches the light-detecting surface of the image pickup element 4R, the green component reaches the light-detecting surface of the image pickup element 4G at an end point 43 in the vertical direction V, and the blue component reaches the light-detecting surface of the image pickup element 4B. The end point 43 is angularly spaced 180° from the end point 44 across the optical axis 7.

The principal ray 22 also passes through the front lens 1 of the camera 13, which refracts the principal ray 22 into a principal ray 33. The principal ray 33 passes through the lens group 2 and thereafter passes through the spectral prism assembly 3. The red component reaches the light-detecting surface of the image pickup element 4R, the green component reaches the light-detecting surface of the image pickup element 4G at the end point 44 in the vertical direction V, and the blue component reaches the light-detecting surface of the image pickup element 4B.

The principal ray 23 passes through the front lens 1 of the camera 13, which refracts the principal ray 22 into a principal ray 34. The principal ray 34 passes through the lens group 2 and thereafter passes through the spectral prism assembly 3. The red component reaches the light-detecting surface of the image pickup element 4R, the green component reaches the light-detecting surface of the image pickup element 4G at the end point 43 in the vertical direction V, and the blue component reaches the light-detecting surface of the image pickup element 4B.

Therefore, the optical systems of the cameras 11, 13 are arranged such that the principal rays 31, 32, 33, 34 which reach the end points 43, 44 of the image pickup element 4G pass through the points 21A, 22A, 23A on the edges of the front lenses 1. These principal rays 31, 32, 33, 34 are separated by the spectral prism assembly 3 and pass through the end points of the image pickup elements 4R, 4B.

As the cameras 11, 13 have their respective image pickup ranges joined to each other without any losses, the images picked up by the image pickup elements 4R, 4G, 4B of the cameras 11, 13 can be combined with each other.

In the angle of view along the vertical direction B which is defined between the two principal rays 21, 23 in the object space, therefore, images can be picked up without blind corners by the two cameras 11, 13.

The plane 39 shown in FIG. 1 represents the same plane with reference number 39 shown in FIG. 3.

The plane 39 and the side surfaces 11A, 13A of the housing of the camera 11, and the plane 39 and the side surfaces 11B, 13B of the housing of the camera 13 jointly define respective spaces S1, S3 in which the spectral prism assemblies 3, the image pickup elements 4R, 4G, 4B, and camera circuits (not shown) of the cameras 11, 13 are accommodated. In this manner, the NP points of the cameras 11, 13 are substantially aligned with each other in the vertical direction V.

The side surfaces 11A, 11B, 13A, 13B of the housings are represented by planes that are described by moving line segments interconnecting the NP points 5 and the points 21A, 22A, 23A on the edges of the front lenses 1 to which the principal rays 21, 22, 23 are applied, in a direction perpendicular to the sheet of FIG. 1.

As described above, the image pickup device 10 according to the present embodiment has the spectral prism assembly 3 (3A, 3B, 3C) for dividing the rays that have passed through the front lens 1 and the lens group 2 into three groups of rays (red light, green light, and blue light) having different wavelengths, and the three image pickup elements 4R, 4G, 4B for detecting the separated groups of rays. Since the number of pixels for detecting the light in each color is greater than the number of pixels on a single-CCD image pickup device, the image pickup device 10 is better in color reproducibility and resolution. The image pickup device 10 is also capable of more efficiently detecting the incident rays for better sensitivity than the single-CCD image pickup device which is unable to detect rays that do not pass through color filters.

The image pickup device 10 that is better in color reproducibility and resolution is thus capable of picking up high-definition images. The image pickup device 10 that is more sensitive provides a sufficient sensitivity level for picking up images at low illuminance levels.

According to the present embodiment, as the NP points 5 of the four cameras 11, 12, 13, 14 are substantially aligned with each other, any parallax between adjacent two of the cameras is almost reduced to nil.

Consequently, the image pickup device 10 can pickup high-quality images in a wide range in a parallax-free manner.

The image pickup device 10 is thus capable of picking up high-definition, high-quality images in a wide range such as an omnidirectional range.

Moreover, the image pickup device 10 provides excellent visibility in a low-luminance environment for picking up high-definition, high-quality images in a wide range.

According to the present embodiment, furthermore, the spectral prism assembly 3 as the separating unit and the image pickup elements 4R, 4G, 4B of each of the cameras 11, 12, 13, 14 are accommodated in the spaces S1, S2, S3 that are defined between the plane 39 extending perpendicularly to the optical axis 7 through the point where the lens surface of the lens of the lens group 2 which is closest to the image pickup element intersects the optical axis 7, and the planes (the side surfaces 11A, 11B, 11C, 11D of the housing in the form of a quadrangular pyramid of the camera 11) interconnecting the NP point 5 and lines from a set of points of intersection between principal rays such as the principal rays 31, 32, 33, 34, 35, 36, 37, 38 and the lens surface 1A of the front lens 1 on the subject side.

Stated otherwise, the spectral prism assembly 3 as the separating unit and the image pickup elements 4R, 4G, 4B are accommodated in the spaces S1, S2, S3 that are left by removing the space which extends from the front lens 1 to the lens of the lens group 2 that is closest to the image pickup element, from the space which is defined between the NP point 5 and the points (21A, 22A, 23A, 24A, 25A, 26A) at which the principal rays (the principal rays 31, 32, 33, 34, 35, 36, 37, 38) applied to the end points 41, 42, 43, 44 on the light-detecting surface of the image pickup element 4G pass through the front lens 1.

Since the spectral prism assembly 3 and the image pickup elements 4R, 4G, 4B are accommodated in the spaces S1, S2, S3, an electric circuit board, cables, etc. can also be accommodated in the spaces S1, S2, S3, allowing adjacent cameras to be coupled together to held the NP points 5 substantially aligned with each other.

The image pickup device 10 can thus be constructed in a compact design.

According to the present embodiment, the housing of each of the cameras 11, 12, 13, 14 is in the form a quadrangular pyramid having a substantially square bottom surface and the front lens 1 is of a substantially square cross-sectional shape. Therefore, the cameras 11, 12, 13, 14 may have their outer peripheral surfaces joined together without gaps. Since the outer peripheral surfaces of the cameras 11, 12, 13, 14 may be joined together without gaps, the image pickup ranges of adjacent ones of the cameras overlap each other from the lens surfaces 1A, which is closer to the subject, of the front lenses 1, leaving no dead corners in front of the image pickup device 10. Since the image pickup range of the image pickup element is usually rectangular or square in shape, the optical system (the lens 1, the lens group 2, the aperture stop, etc.) may be arranged such that the principal rays having passed through the edges of the front lens 1 which has a substantially square cross-sectional shape reach pixels at the edges of the image pickup range of the image pickup element. In this manner, a sufficient amount of light reaches the pixels at the corners of the image pickup range which may be square or rectangular in shape, for thereby effectively utilizing the image pickup range of the image pickup element.

If the bottom surface of the housing and the front lens of each of the cameras are rectangular in shape, the image pickup device has essentially the same advantages as described above.

If the cameras are of a conical shape, then since gaps are created between the front lenses of adjacent cameras, a dead corner is produced which is not included in the image pickup range of either one of the cameras within zones up to overlapping image pickup ranges. As an image that reaches each image pickup range is circular or elliptical in shape, no light reaches the pixels at the corners of the image pickup range which may be square or rectangular in shape, for thereby reducing the efficiency with which to utilize the image pickup element.

As described above, surveillance cameras or the like are highly required to pickup images of subjects in low-luminance environments.

Single-CCD cameras for picking up images in an omnidirectional range or a wide-angle or broad range have a low light detecting sensitivity level because the color filters absorb light and the colors are separately assigned to the pixels. Therefore, it is difficult for these cameras to pickup images of low-luminance subjects.

It may be proposed to apply the principles of the present invention to separate incident rays with prisms and detect the separated incident rays with image pickup elements for detecting visible light and an image pickup element for detecting infrared radiation. Such an arrangement will be described below.

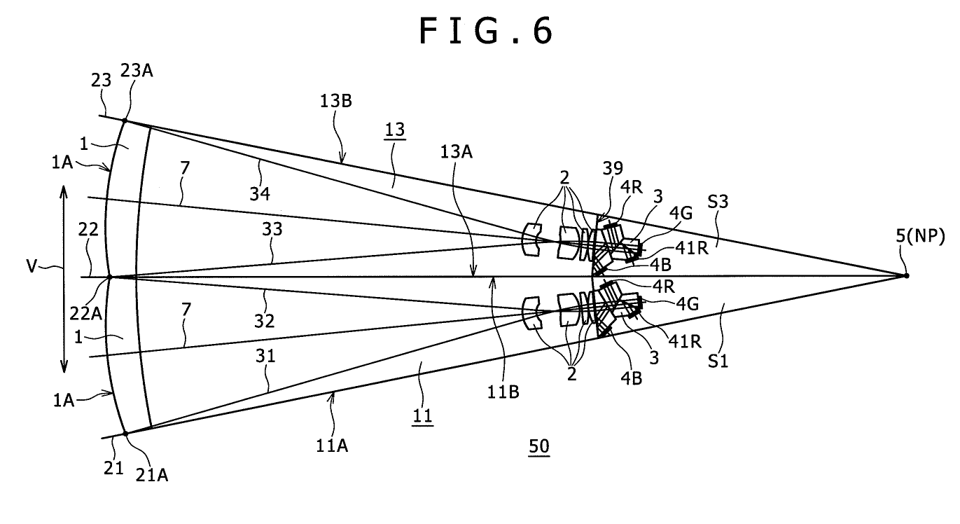

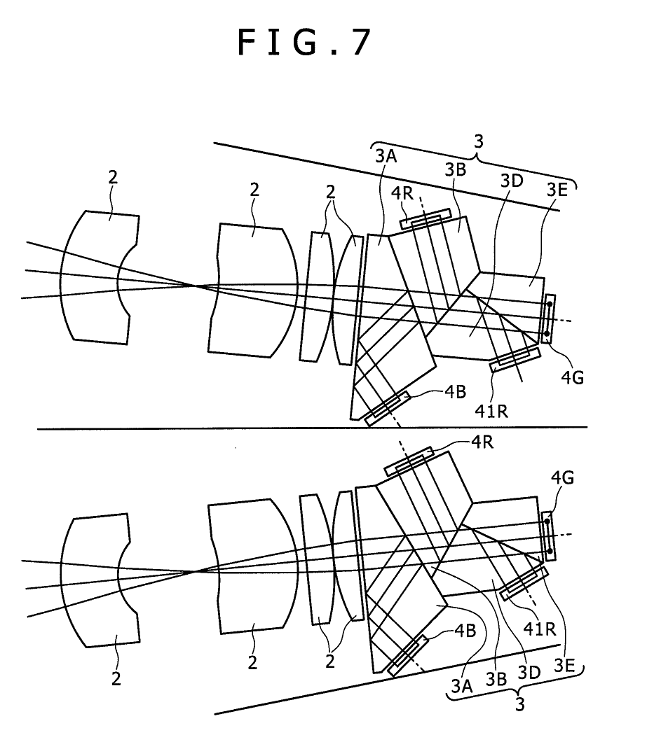

An image pickup device according to another embodiment of the present invention will be described below with reference to FIGS. 6 and 7. FIG. 6 is a schematic vertical cross-sectional view of the image pickup device, and FIG. 7 is an enlarged vertical cross-sectional view of a central portion of the image pickup device shown in FIG. 6.

The image pickup device according to the present embodiment employs four lenses and four cameras to pickup high-definition images in a wide range, as with the image pickup device according to the embodiment shown in FIGS. 1 through 5.

The structural details of the image pickup device according to the present embodiment as viewed in horizontal cross section are identical to those of the image pickup device 10 according to the previous embodiment, and hence will not be illustrated and described in detail below.

In the image pickup device 10 according to the previous embodiment, the visible light whose wavelength ranges from 400 nm to 700 nm is applied to the spectral prism assembly 3 (the prisms 3A, 3B, 3C), which separates the light into blue, green, and red lights that reach and are detected by the image pickup elements corresponding to the respective wavelengths.

The image pickup device 50 according to the present embodiment incorporates a spectral prism assembly 3 including four prisms 3A, 3B, 3D, 3E in each camera, the prisms 3D, 3E being positioned in place of the third prism 3C of the image pickup device 10 according to the previous embodiment. An optical film for separating visible incident light according to wavelength is disposed between boundary surfaces of each of the prisms 3A, 3B, 3D, 3E and an adjacent one of the prisms 3A, 3B, 3D, 3E.

The image pickup element 4B for detecting the blue light is mounted on the first prism 3A which is closest to the lens group 2. The image pickup element 4R for detecting the red light is mounted on the second prism 3B which is disposed next to the first prism 3A. An image pickup element 4IR for detecting the infrared radiation is mounted on the third prism 3D which is disposed next to the second prism 3B. The image pickup element 4G for detecting the green light is mounted on the fourth prism 3E which is disposed farthest from the lens group 2.

Since the image pickup element 4IR is mounted on the third prism 3D, the optical film disposed between the boundary surfaces of the third prism 3D and the fourth prism 3E comprises an optical film for reflecting the infrared radiation and passing the green light.

Of the light that has passed through the lens group, the visible light and the infrared radiation in a wavelength range from about 400 nm to about 1000 nm are applied to the spectral prism assembly 3 and separated thereby.

The infrared radiation in a wavelength range from about 700 nm to 1000 nm reaches the light detecting surface of the image pickup element 4IR. Of the visible light whose wavelength ranges from 400 nm to 700 nm, the blue component reaches the light-detecting surface of the image pickup element 4B, the green component reaches the light-detecting surface of the image pickup element 4G, and the red component reaches the light-detecting surface of the image pickup element 4R.

The image pickup elements 4IR, 4G, 4R, 4B are positioned such that sharp images are focused on their respective light detecting surfaces by the lights in the respective wavelengths. When the four images produced by the image pickup elements 4IR, 4G, 4R, 4B are combined into a single image, the combined image is kept in focus.

Other structural details of the image pickup device 50 are identical to those of the image pickup device 10 according to the previous embodiment, and will not be described in detail below.

According to the configuration of the image pickup device 50 of the present embodiment, as the NP points 5 of the four cameras 11, 12, 13, 14 are substantially aligned with each other, any parallax between adjacent two of the cameras is almost reduced to nil, as with the image pickup device 10 of the previous embodiment.

Consequently, the image pickup device 50 can pickup high-quality images in a wide range in a parallax-free manner.

The spectral prism assembly 3 (the prisms 3A, 3B, 3D, 3E) separates the rays that have passed through the front lens 1 and the lens group 2 into four groups of rays having different wavelengths (the infrared radiation, the red light, the green light, and the blue light), and the four image pickup elements 4IR, 4R, 4G, 4B detect the respective groups of rays. Therefore, the image pickup device 50 is better in color reproducibility and resolution than the single-CCD image pickup device, and has better sensitivity than the single-CCD image pickup device.

Particularly, inasmuch as the infrared radiation is separated from the rays that have passed through the front lens 1 and the lens group 2 and detected by the image pickup element 4IR, an image can be produced from the infrared radiation. Consequently, the image pickup device 50 provides better visibility in a low-luminance environment than the image pickup device 10 according to the previous embodiment.

The image pickup device 50 thus provides excellent visibility in a low-luminance environment for picking up high-definition, high-quality images in a wide range.

The image pickup element 4IR for detecting the infrared radiation may be of a structure different from the other image pickup elements 4R, 4G, 4B for detecting the visible light. For example, the image pickup element 4IR may include a photodiode as a solid-state image pickup element deeply formed for increasing the efficiency with which to detect the infrared radiation, or may be specially designed for detecting a longer wavelength of the infrared radiation.

The wavelength range to be detected by the image pickup element 4IR is not limited to the range from about 700 nm to 1000 nm, but may be another range such as a wider range or a narrower range. Depending on the wavelength range to be detected by the image pickup element 4IR, the image pickup element 4IR itself and the optical film for separating the infrared radiation may be constructed.

The image pickup device 10 shown in FIGS. 1 through 5 may be modified such that the image pickup element combined with the second prism 3B is capable of detecting both the red light and the infrared radiation. In this case, the optical film between the second prism 3B and the third prism 3C should be able to reflect not only the infrared radiation, but also a near-infrared radiation.

The spectral prism assembly may include two prisms for separating the visible light in a wavelength range from about 400 to about 1000 nm into a visible light in a wavelength range from about 400 nm to about 700 nm and an near-infrared radiation in a wavelength range from about 700 to about 1000 nm, and two image pickup elements may be employed for detecting the visible light and the near-infrared radiation that have been separated in the respective wavelength ranges.

In each of the above embodiments, each of the cameras 11, 12, 13, 14 of the image pickup devices 10, 50 has a housing in the form of a quadrangular pyramid having a substantially square-shaped bottom surface. However, the bottom surface of the housing may be of a rectangular shape having different vertical and horizontal lengths. For example, the bottom surface of the housing may be of a rectangular shape matching the aspect ratio (3:4 or 9:16) of the display screen of a television set.

In each of the above embodiments, the separating unit for separating rays into a plurality of groups of rays according to wavelength includes the spectral prism assembly 3 including the prisms with the optical films interposed therebetween.

However, the separating unit according to the present invention may be of any of various other structures. For example, optical films for separating rays may be disposed on the surfaces of glass plates, as with those used on projectors or the like. The separating unit should be constructed so as not to be too large compared with the respective image pickup units (cameras or the like).

However, the spectral prism assembly 3 including the prisms joined together according to the above embodiments is more advantageous than the glass plates because it allows the optical system to be adjusted with ease for higher accuracy.

In each of the above embodiments, the spectral prism assembly 3 and the image pickup elements 4R, 4G, 4B, 4IR are accommodated in the spaces S1, S2, S3 defined between the plane extending perpendicularly to the optical axis 7 through the point of intersection between the lens surface, closer to the image pickup element, of the lens group 2 and the optical axis 7, and the outer peripheral surfaces of the camera housing. This arrangement makes it possible to simplify the structure of the image pickup device and reduce the size of the image pickup device.

However, it is not mandatory for the image pickup device according to the present invention to accommodate the separating unit and the image pickup elements in those spaces. For example, it is possible to mount image pickup elements on outer peripheral surfaces of the housings which are opposite to the surfaces on which adjacent image pickup unit (cameras or the like) are mounted, e.g., on the surfaces 11A, 11C shown in FIG. 5 (see, for example, Japanese Patent Laid-open No. 2006-30664 which is based on an earlier application filed by the present applicant), or also to position the separating unit so as to extend beyond outer peripheral surfaces of the housings. If the image pickup device is constructed in this way, then the housings of the image pickup unit have portions projecting from the quadrangular pyramid. The image pickup device thus constructed is also better in color reproducibility and resolution, and is capable of picking up images in a wide range in a parallax-free manner with the plural image pickup units that are joined together.

In each of the above embodiments, the NP points 5 of the four cameras 11, 12, 13, 14 are substantially aligned with each other. According to the present invention, the NP points 5 of the four cameras 11, 12, 13, 14 may be placed in a region having a radius of about 20 mm around one of the NP points 5. With the NP points 5 being placed in such a region, the images produced by the image pickup elements of each of the image pickup units can be combined together in a parallax-free manner.

Although certain preferred embodiments of the present invention have been shown and described in detail, it should be understood that various changes and modifications may be made therein without departing from the scope of the appended claims.

What is claimed is:

1. An image pickup device comprising:
a plurality of image pickup means for picking up images of a plurality of respective subject segments divided from a subject in a wide range; and
processing means for combining the images picked up by said image pickup means into a single image;
each of said image pickup means including lenses and image pickup elements for detecting rays having passed through said lenses;
wherein in each of said image pickup means, an NP point is defined as a point where the extensions of straight components, in an object space, of principal rays positioned in a Gaussian region which are selected from a number of principal rays passing through the center of an aperture stop associated with said lenses, intersect an optical axis of said image pickup means;
said NP point is set behind said image pickup elements, and the NP points of said image pickup means are placed in a region having a radius of about 20 mm around one of said NP points; and
each of said image pickup means includes separating means for separating the rays having passed through said lenses into a plurality of groups of rays having different wavelengths which are to be detected by said image pickup elements, respectively.

2. The image pickup device according to claim 1, wherein said separating means is accommodated in a space defined between a plane extending perpendicularly to said optical axis through a point where a lens surface of one of said lenses which is closest to said image pickup element, and planes interconnecting said NP point and lines from a set of points of intersection between the selected principal rays and a lens surface of another one of said lenses which is closest to a subject.

3. The image pickup device according to claim 2, wherein said image pickup elements each of which detecting a plurality of groups of rays are accommodated in said space.

4. The image pickup device according to claim 1, wherein said separating means separates the rays in a wavelength range from about 400 nm to about 700 nm into rays in three wavelength ranges corresponding to blue, green, and red, and said image pickup elements include three image pickup elements for detecting the separated rays in the respective three wavelength ranges.

5. The image pickup device according to claim 1, wherein said separating means separates the rays in a wavelength range from about 400 nm to about 1000 nm into visible light in a wavelength range from about 400 nm to about 700 nm and a near-infrared radiation in a wavelength range from about 700 nm to about 1000 nm, and said image pickup elements include two image pickup elements for detecting the visible light and said infrared radiation, respectively.

6. The image pickup device according to claim 1, wherein said separating means separates the rays in a wavelength range from about 400 nm to about 1000 nm into rays in three wavelength ranges corresponding to blue, green, and red and near-infrared radiation, and said image pickup elements include three image pickup elements for detecting the separated rays in the respective three wavelength ranges.

7. The image pickup device according to claim 1, wherein said separating means separates the rays in a wavelength range from about 400 nm to about 1000 nm into rays in four wavelength ranges corresponding to blue, green, red, and near-infrared radiation, and said image pickup elements include four image pickup elements for detecting the separated rays in the respective four wavelength ranges.

8. The image pickup device according to claim 1, wherein said separating means is disposed between said lenses and said image pickup elements.

9. The image pickup device according to claim 1, wherein one of said lenses which is closest to a subject has a square or rectangular cross-sectional shape in each of said image pickup means, and each of said image pickup means includes a housing in the form of a quadrangular pyramid which houses said lenses therein.

10. An image pickup device comprising:
a plurality of image pickup unit configured to pick up images of a plurality of respective subject segments divided from a subject in a wide range; and
a processing unit configured to combine the images picked up by said image pickup unit into a single image;
each of said image pickup unit including lenses and image pickup elements for detecting rays having passed through said lenses;
wherein in each of said image pickup unit, an NP point is defined as a point where the extensions of straight components, in an object space, of principal rays positioned in a Gaussian region which are selected from a number of principal rays passing through the center of an aperture stop associated with said lenses, intersect an optical axis of said image pickup unit;
said NP point is set behind said image pickup elements, and the NP points of said image pickup units are placed in a region having a radius of about 20 mm around one of said NP points; and
each of said image pickup units includes a separating unit for separating the rays having passed through said lenses into a plurality of groups of rays having different wavelengths which are to be detected by said image pickup elements, respectively.
